(19) United States
(12) Patent Application Publication
(10) Pub. No.: US 2012/0226905 A1
(43) Pub. Date: Sep. 6, 2012

(54) Method and System for Discovering, Authenticating and Accessing Multiple Computing Devices

(75) Inventors: Subhashis Mohanty, San Diego, CA (US); Troy Schilling, Salt Lake City, UT (US)

(73) Assignee: TOR ANUMANA, INC., La Jolla, CA (US)

(21) Appl. No.: 13/406,138

(22) Filed: Feb. 27, 2012

Related U.S. Application Data
(60) Provisional application No. 61/448,404, filed on Mar. 2, 2011.

(51) Int. Cl. H04L 9/32; H04L 9/00

(52) U.S. Cl. 713/168; 713/150

(57) ABSTRACT

The system and methods disclosed allows devices, possibly on different networks, to discover, access and authenticate one another. When the target device is on the same network as the source device (or is otherwise directly addressable by the source device), the system provides a mechanism by which the source device can connect directly to the target device; otherwise, the system provides a mechanism by which the source and target devices may communication with one another using a commonly accessible computing device as a proxy. In the latter case, the mechanism is such that it is not technologically feasible for the proxy device to decipher communications between the source and target devices. The system accommodates dynamic change in network location (e.g. IP address) without requiring reconfiguration by the user, and mitigates problems introduced by the existence of firewalls.

### TECHNICAL FIELD

The present invention relates to systems and methods for the discovery, authentication and access of multiple computing devices.

### BACKGROUND

The proliferation of computing devices has been extraordinary over the course of the last two decades. The last decade has fostered the interconnectivity of these devices through various computing networks such as the Internet. Users often have several computing devices that they would like to access without breaching or compromising existing security protocols. For example, in FIG. 1A, a system 100A of three computing devices is shown. The first computing device (105) is a PDA that is located behind a home firewall (HF) (110). A second computing device (115) is a laptop computer that is connected to a public wireless network with a firewall (118), and the third computing device (120) is a personal computer and it is located behind a corporate firewall (CF) (125). A firewall is a designed to prevent unauthorized access to or from a private network. Firewalls can be implemented in both hardware and software, or a combination of both. Firewalls are frequently used to prevent unauthorized Internet users from accessing private networks connected to the Internet, especially intranets. All messages entering or leaving the intranet pass through the firewall, which examines each message and blocks those that do not meet the specified security criteria. The three devices in FIG. 1A are, in general, not directly addressable by one another (they do not have public IP addresses). The owner(s) of these devices desire a mechanism by which (s)he can access these devices from one another.

FIG. 1B illustrates the movement of computing devices from various network locations behind firewalls. Here, the second computing device (115) has moved from its previous network location, to a position where it is behind the same personal firewall 110 as the first computing device (105). As a result of this change in network location, the IP address of the second computing device changed, and the first two devices are directly addressable by one another. Such a movement is common for example, when the second computing device (115) is at first connect to a public wireless network, and then the user brings the device home and accesses his personal home network, rendering the device (115) behind the home firewall (110).

The device user(s) desires a mechanism in which such network movements is transparent to him, and does not affect the connectivity of his devices. Moreover, the user(s) desires a mechanism for which connectivity between devices is direct (peer-to-peer) whenever the target device is directly addressable by the source device. The key problems that should be addressed are:
a. The addresses of the entities in question (sources and targets) are not assumed to be static. For example, the target may be a laptop computer that is dynamically assigned an IP address, which therefore varies from time to time. How can a source device discover (e.g. determine the IP address and/or other relevant connection parameters for) a target device of interest?
b. Reconfiguring a CF/HF is a challenging and/or confusing task for many users;

in some cases it is simply not possible. How can a source discover, and connect to a target device that is behind a CF/HF in a way that does not require prior configuration of the CF/HF?
c. It is crucial that the mechanisms developed to address the above two questions are secure. How can the administrator of target devices limit access to specific source device users/operators and/or specific source devices?
d. Similarly, how can the source device authenticate the target device (i.e. to be certain that the device to which it is connecting is the intended device)?

The solution should be such that no enabling element of the system (e.g. the entity management server (EMS) defined below) be trusted with information sufficient to gain access to source or target devices, or to the information exchanged between them.

### SUMMARY

The system and methods disclosed herein overcomes these challenges and allows devices to discover, access and authenticate one another. The system works when the target device is on the same network as the source device and works when the devices are on different networks. A method for establishing a connection between a source computing device and a target computing device wherein both devices are connected to a network and a previous address for the target device is known to the source device. The method includes the steps of the source device initiating a connection with the target device based on the previous address for the target device and when such a connection is not successful, then the source device initiates a connection to a entity management server (EMS) and communicates its desire to EMS to make a connection to the target device. The EMS determines whether the target device is currently connected to the EMS and when both the target and source are connected to the EMS, then the method establishing a communication channel through the EMS such that the source and target devices can securely communicate directly with each other in such a way that it is not technologically feasible for EMS to decipher the communications. On the communication channel, a trusted communication between the first and second devices using asymmetric and symmetric cryptography is established and communications are routed from the target device to the source and from the source device to the target over the trusted communication channel.

In another embodiment the method also includes determining a public cryptographic key for the source device and encrypting data routed from the target device to the source device with the public cryptographic key for the source device. The method further determines a public cryptographic key for the target device and encrypting data routed from the source device to the target device with the public cryptographic key for the target device.

An entity management server (EMS) for establishing a connection between a source computing device and a target computing device wherein the EMS, the source computing device, and the target computing devices are connected to a network, the EMS includes memory and a computer configured to perform several steps. Those steps include determining the following attributes of the source device: (1) an identifying label; an address within the network where the source device can be located; and (2) a list of other network devices that are authorized to communicate with the source device, and storing these attributes of the source device in the memory. Other steps include determining the following attributes of the target device: (1) an identifying label; (2) an address within the network where the target device can be located; (3) and a list of other network devices that are authorized to communicate with the target device, and storing these attributes of the target device in the memory. The computer further performs the steps of confirming that the source device and target device are authorized to communicate with each other, establishing a trusted communication between the source and target devices using asymmetric and symmetric cryptography; and routing communications from the source device to the target device and from the target device to the source device. Other aspects of the invention are disclosed herein as discussed in the following Drawings and Detailed Description.

### BRIEF DESCRIPTION OF THE DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views. It will be understood that certain components and details may not appear in the figures to assist in more clearly describing the invention.

FIG. 1A illustrates a system comprised of three computing devices.

FIG. 1B illustrates a system comprised of three computing devices as in FIG. 1A, but where some of the devices have moved behind various firewalls.

FIG. 2 illustrates a method of establishing a secured connection between two entities according to the example embodiments.

FIG. 3 illustrates method for user registration according to the example embodiments.

FIG. 4 illustrates method for device registration according to the example embodiments.

FIG. 5 illustrates method for access rules registration according to the example embodiments.

FIG. 6 illustrates method for network location registration according to the example embodiments.

FIG. 7 illustrates the method according the example embodiment when a device comes on line with the entity management server (EMS).

FIG. 8 illustrates the method according the example embodiment when a source entity attempts to contact a target entity.

FIG. 9 illustrates the method according the example embodiments where a source entity can establish a connection with a firewall-blocked (FB) target entity.

FIGS. 10A-10C illustrate a method according the example embodiments, wherein the user has several devices that he would like to discover and access as the devices move to network locations behind various firewalls.

FIGS. 11A-11C illustrate a method according the example embodiments, wherein the user has several devices that he would like to discover and access as the devices move to network locations behind various firewalls, and would like to grant limited access to a third party.

FIG. 12 illustrates a method according the example embodiments, wherein the user has several devices that he would like to discover and access, and would like to grant limited access to a third party.

FIG. 13 illustrates a method according the example embodiments, wherein the user has several devices that he would like to discover and access, and would like to grant limited access to a third party.

### DETAILED DESCRIPTION

The system and methods disclosed herein allows devices, possibly on different networks, to discover, access and authenticate one another. When the target device is on the same network as the source device (or is otherwise directly addressable by the source device), the system provides a mechanism by which the source device can connect directly to the target device. The system accommodates dynamic change in network location (e.g. IP address) without requiring reconfiguration by the user, and mitigates problems introduced by the existence of firewalls.

To implement this system, an EMS whose coordinates and public key are well known is used. The primary role of the EMS is to perform services sufficient to allow source devices to discover target devices of interest, and to facilitate secure connection to firewall-blocked (FB) targets. A target device is FB relative to a given source device if there exists a firewall that blocks direct data communications from the source to the target. Otherwise, a target is called non-firewall-blocked (NFB) relative to the source device. (Note that a target may be NFB relative to one source, but FB relative to another. Note also that firewall blockage may depend on additional communication details, such as the type of data of interest and/or the intended target port). EMS may act as a key server, providing a trusted certificate (containing a public key) associated with a target device when needed by a source device. EMS may also provide other services, such as account management, providing source devices with status of target devices of interest to them, etc. Note that EMS is NFB relative to any device with Internet access.

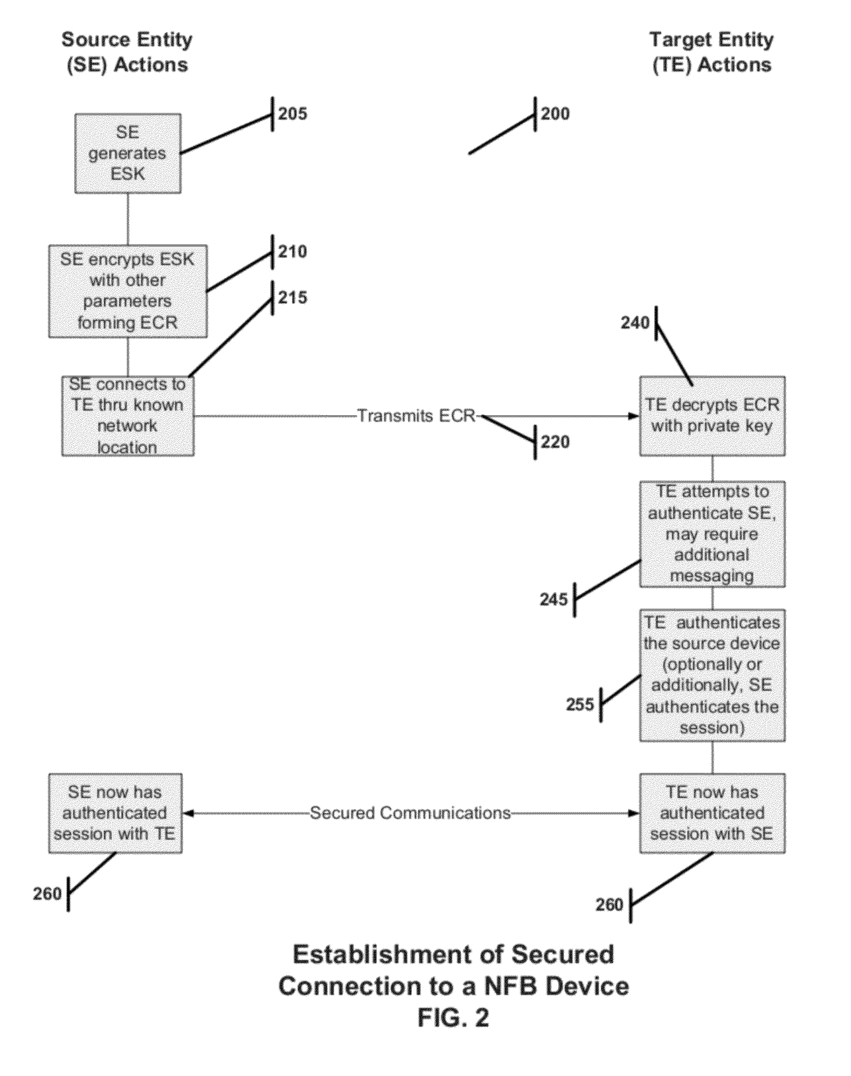

Presented in FIGS. 2-9 are several methods that may be implemented to register a user and his devices on the system, and to establish a connection between devices. The methods will first be described in the abstract with details as to each step that comprises the method. Then several examples will be presented that illustrate how these methods can be used to allow devices, possibly on different networks, to discover, access and authenticate one another.

FIG. 2 illustrates the method (200) for establishing a secure connection. The term “connection” may refer to a single two-way connection, or a pair of one-way connections. While the following figure refers to a source entity and target entity, it should be appreciated that this method can be used by any pair of components. For example, the target entity may be either the EMS or a user device.
Step 205: The source entity generates a session key (ESK) (symmetric cipher key such as an AES Rijndael Key).
Step 210: The source entity encrypts the ESK, source user credentials for the target entity, and any other applicable session parameters (e.g. parameters specifying the nature of the source entity) using the target entity's public key. Denote this encrypted connection request as ECR.
Step 215: Source entity connects to target entity using target entity's known connection coordinates.
Step 220: Source entity transmits the ECR to the target entity.
Step 240: Target entity decrypts the ECR using the target entity's private key.
Step 245: Target entity evaluates the source entity's credentials in order to authenticate the source entity .
Step 255: The authentication mechanism may involve one or more messages between the source and target entities; in this case, all such messages are encrypted with either the ESK or the public key of the destination device for the message. Optionally, the target device may authenticate the source device (in addition to, or instead of, the source entity authentication just described). Source entity authentication can be accomplished as follows: the target entity generates a random challenge, and encrypts it with the public key of the source entity; the target entity transmits the encrypted challenge to the source entity; the source entity decrypts with its private key and transmits the result to the target entity; the target entity verifies that the response coincides with the original challenge it generated (proving that the source entity possesses its private key).
Step 260: Subsequent communications between source and target entities may now be secured by encryption with the ESK.

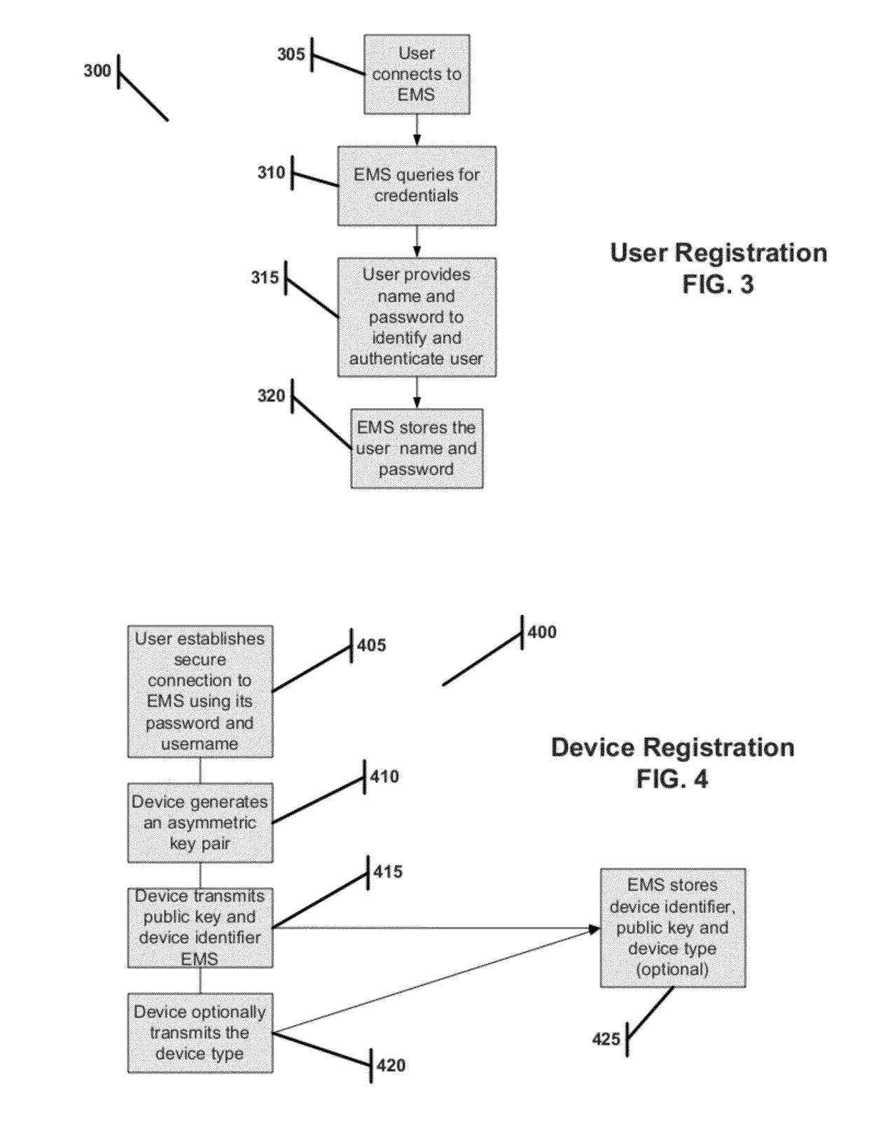

FIG. 3 illustrates the method (300) for registering a user with the EMS.
Step 305: User connects to EMS
Step 310: EMS queries the user for a credentials
Step 315: User provides the requested information
Step 320: The EMS stores the provided information for use in further identification and authentication.
   As part of the User Registration process, EMS may take steps to authenticate the requesting user. For example, EMS might send an email to the user and finalize the registration process only after receiving confirmation (e.g. by email response) that the user has received the email.

FIG. 4 illustrates the method (400) for registering a device with the EMS.
Step 405: The user establishes a secure connection (see FIG. 2) with EMS (see

FIG. 2). Note that only user authentication (not device authentication) is possible at this point, since the device has not yet been registered.
Step 410: Device locally generates an asymmetric key pair.
Step 415: Device transmits the public key, along with an associated device identifier (e.g. device name) to EMS. The nature of the device identifier is not key to this disclosure, except that the combination of user credentials and device handle should uniquely specify the device. Optionally (Step 420), the device identifier actually consists of two quantities: a deviceID, which is dependent on hardware quantities, and a deviceName, selected by the device operator.
Step 425: EMS stores the device identifier / public key pair, and associates that pair with the authenticated user. And optionally, the EMS stores device type. The device type may include information indicating whether the device can play the role of a source, of a target, or of both. At this point, the connection may, or may not, be closed.

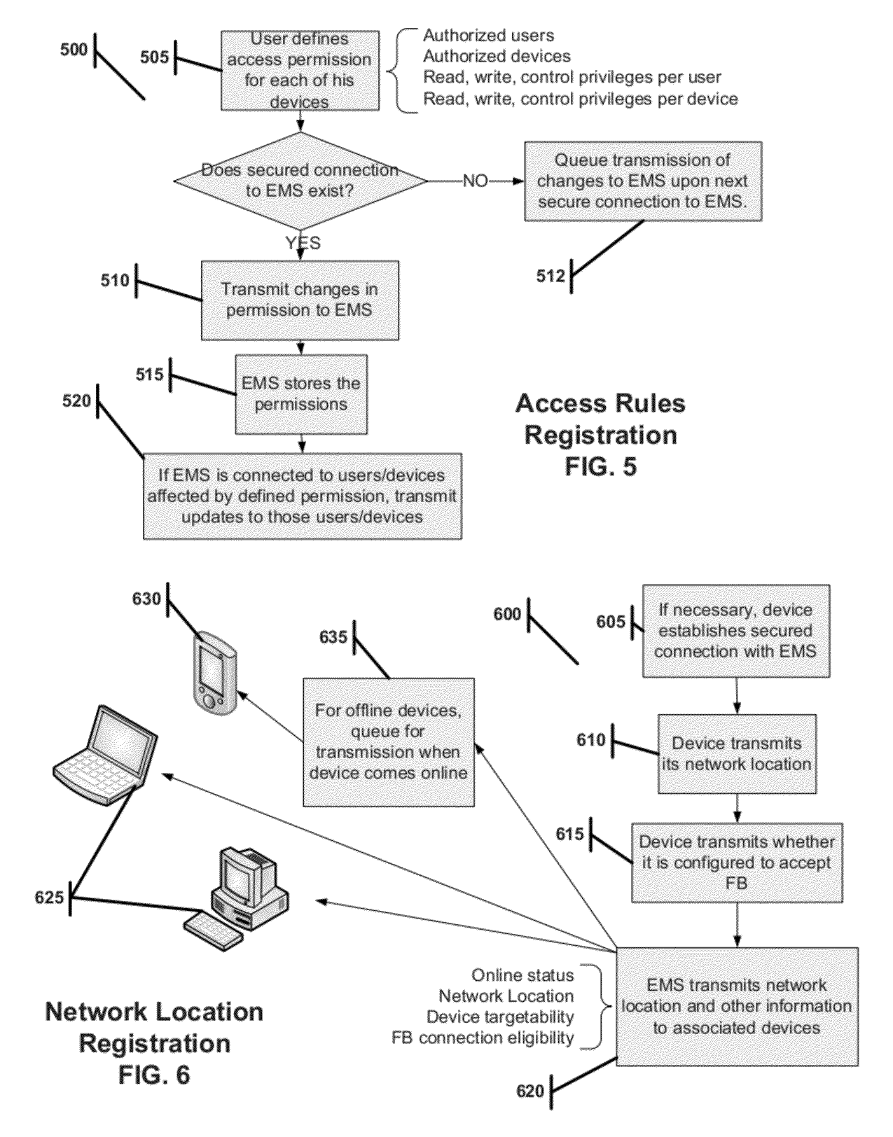

FIG. 5 illustrates the method (500) for registering the access rules with the EMS.
Step 505: Device administrator (e.g., the system user who registered the device) specifies permissions for access to device, which may include:
   authorized users
   authorized devices
   read, write, delete, control privileges per user
   read, write, delete, control privileges per device
Step 510: If secured connection to EMS exists, then transmit changes in permission to EMS
Step 512: If secured connection to EMS does not exist, then Queue transmission of changes to EMS upon next secure connection to EMS
Step 515: EMS stores the permissions.
Step 520: If a secure connection to EMS exists, transmit to EMS updates to those access rules that require distribution (authorized users, authorized devices).

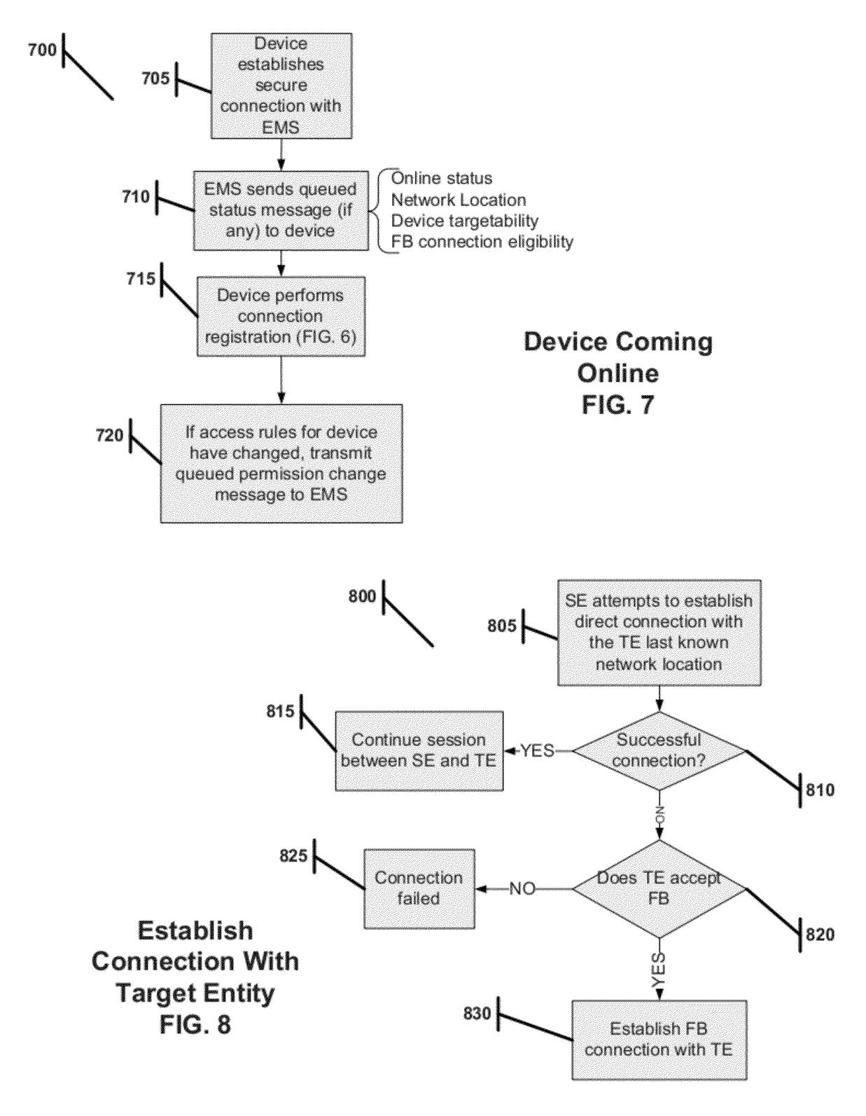

FIG. 6 illustrates the method (600) for registering network location with the EMS. This function is executed each time a device “comes online”; i.e. each time the device is put in a state of readiness to act as a source or target. It is executed each time the device's network location changes. It is executed each time the device FB options change (see below).
Step 605: If necessary, device establishes a secure connection to EMS (method 200, FIG. 2).
Step 610: Device transmits its network location (e.g. its IP address, etc.) to EMS.

Note that the network location may not be NFB relative to EMS (e.g., the device may transmit a local IP address, associated with an internal network not directly accessible by EMS).
Step 615: Device transmits whether it is configured (by the device administrator) to accept FB connections.
Step 620: EMS transmits (pushes) connection status/coordinates for device in question to all other devices that are associated with the device in question (e.g. devices granted privileges to access or control the device in question showing as devices 625). The information transmitted contains online status, network location, FB connection eligibility (whether the device in question is configured to accept FB connections) and other information.
Step 635: For associated devices that are offline (i.e., device 630) a status update is queued for delivery when the device comes online

FIG. 7 illustrates the method (700) applied when a devices comes on line with the EMS. This can either by when a device is commanded by a human user or by automated means (e.g. at system start).
Step 705: Device establishes a secure connection to EMS (method 200, FIG. 2).
Step 710: EMS transmits queued status messages to device (e.g. changes in connection status/connection of other devices since last update).
Step 715: Device performs Connection Status/Coordinate Registration (method 600, FIG. 6)
Step 720: If access rules have changed since last access rules registration update, transmit queued permission change message to EMS. The secure connection may be maintained while the device is “online” (and may be used by EMS to push messages such as status updates to the device).

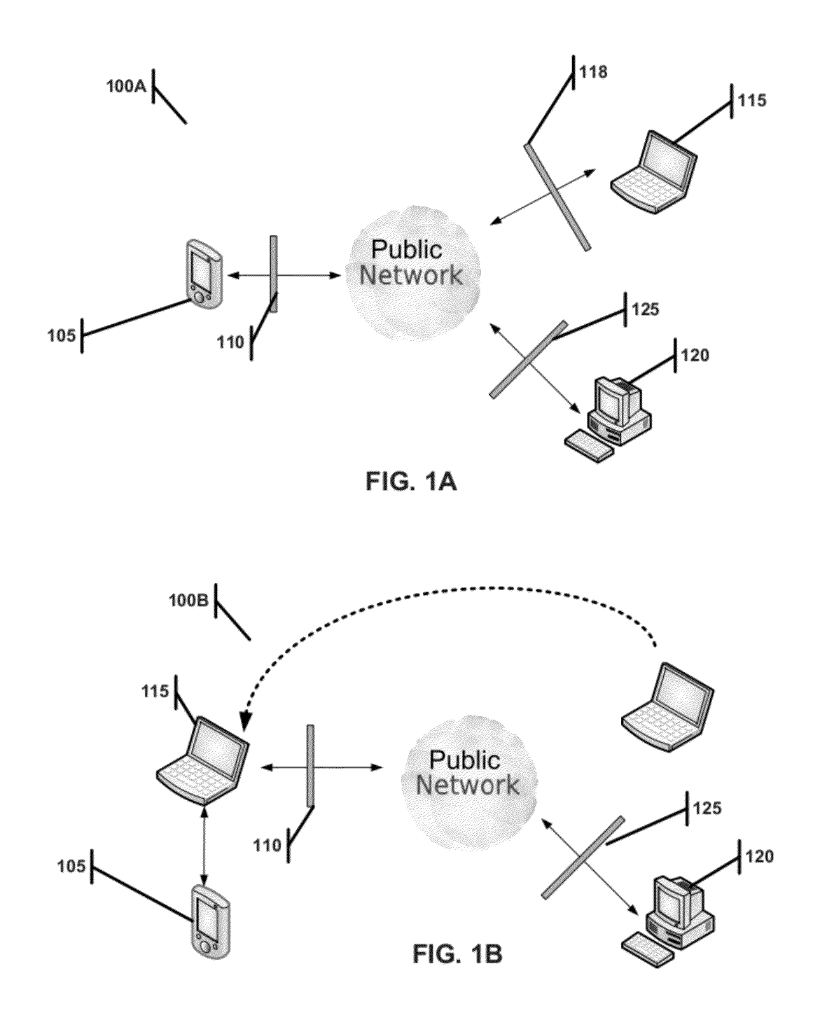

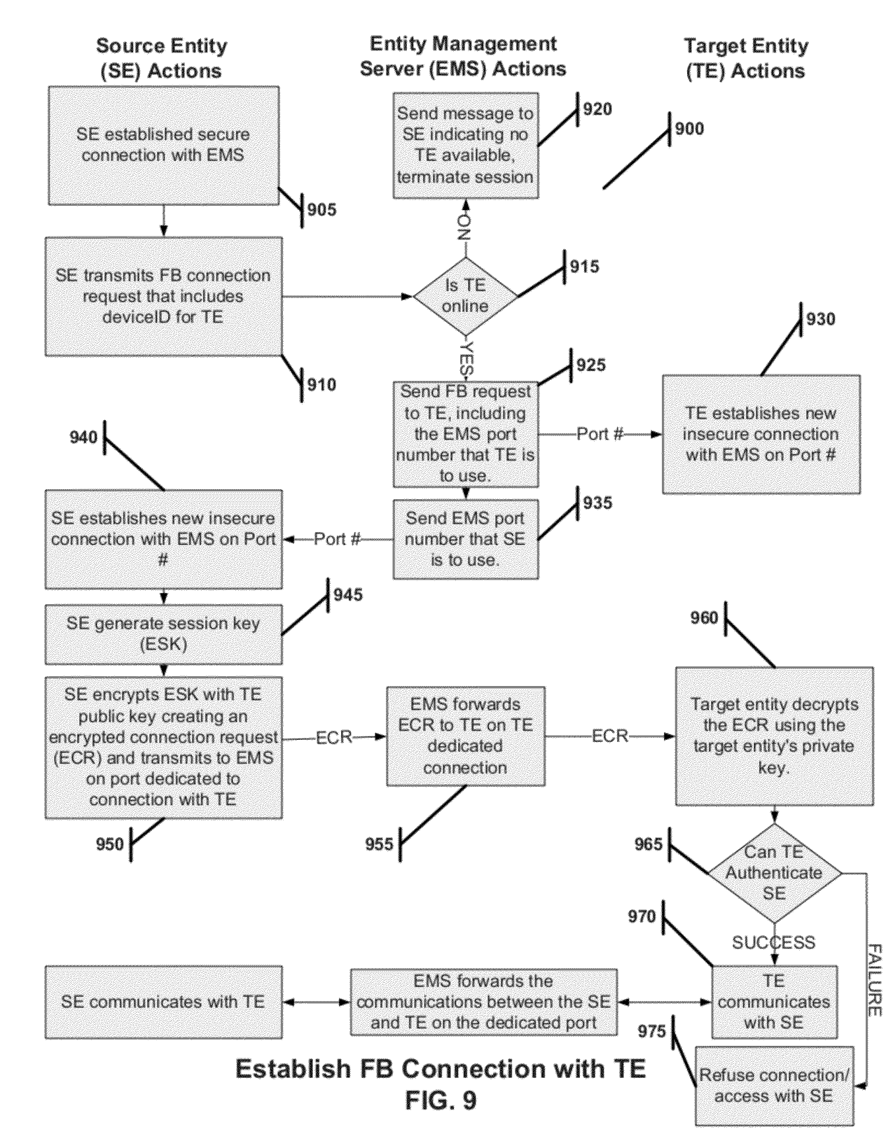

FIG. 8 illustrates the method (800) when a source entity attempts to contact a target entity. The benefit of this method is that it may be possible that the target entity may by directly routable, in which case it is not necessary to use the EMS to facilitate the communication. This is shown in FIG. 1B, where both the first and second computing devices 105 and 115 are behind the same home firewall 110. It would not be necessary to use the EMS here because the devices could communicate with each other directly.
Step 805: Source attempts to establish secure connection with target (method 200, FIG. 2).
Step 810: If this connection is successful then continue session between the source entity and the target entity (Step 815).
Step 820; If the connection is not successful, then determine if target profile indicates that target is configured to accept FB connections
Step 825: If FB connection is not allowed, then connection fails.
Step 830: If FB is allowed, establish FB connection with target using method 900, FIG. 9.

FIG. 9 illustrates the method (900) where a source entity can establish a connection with a FB target entity.
Step 905: If necessary, source establishes a secure connection with EMS (method 200, FIG. 2)
Step 910: Source transmits FB connection request to EMS. This connection request includes the deviceID of the target device.
Step 915: The EMS determines whether the Target entity is online (in which case the TE has established a connection to EMS).
Step 920: If the target entity is not online, then the EMS sends a message to the source entity so indicating, and may terminate the session.
Step 925: If the target entity is online, then using the existing connection between the target and EMS, EMS sends a FB connection request notification to the target; this notification includes an EMS port number on which the target shall establish a connection dedicated to the source.
Step 930: Target entity establishes a new (insecure) connection to EMS on the designated port.
Step 935: EMS sends to the source entity a message with the port number, on which the source shall establish a connection dedicated to the target.
Step 940: Source entity establishes a new (insecure) connection to EMS on the designated port.
Step 945: Source entity generates a session key (ESK) (symmetric cipher key such as an AES Rijndael Key).
Step 950: Source entity encrypts the ESK, source user credentials for the target entity, and any other applicable session parameters (e.g. parameters specifying the nature of the source device) using the target's public key. Denote this encrypted connection request as ECR. This is transmitted to the EMS on the designated port.
Step 955: EMS forwards the ECR, unchanged, to the target, on the designated port. Note that since EMS does not possess the target's private key, the ECR cannot be deciphered by EMS.
Step 960: Target entity decrypts the ECR using the target entity's private key.
Step 965: Target entity attempts to authenticate the source entity. Target entity evaluates the source user credentials in order to authenticate the source user. The authentication mechanism may involve one or more messages between the source and target; in this case, all such messages are encrypted with either the TSK or the public key of the destination device for the message. Optionally, the target device may authenticate the source device (in addition to, or instead of, the source device user). Source device authentication can be accomplished as follows: the target device generates a random challenge, and encrypts it with the public key of the source; target transmits the encrypted challenge to the source; source decrypts with its private key and transmits the result to the target; target verifies that the response coincides with the original challenge it generated (proving that the source possesses its private key). If messaging is required for authentication, it is performed simply by routing messages through EMS, with EMS routing appropriately. EMS is not capable of deciphering these messages.
Step 970: If the target can authenticate the source, then it can communicate with the source entity through the EMS. Again, the EMS cannot decipher this communication because it does not have the session key. At this point, the EMS has created a trust channel over which the target and source can maintain a secured connection.
Step 975: If the target cannot authenticate, then it refuses the connection with the source.

It should be noted that the method just described with reference to FIG. 9 is secure as between the source entity and the target entity. Recall that the source entity establishes a secured session connection with the EMS for the purpose of instructing the EMS that it would like to communicate with a particular target entity. The EMS then determines whether the target entity is available and online. If so, then the target entity had also established a secured session connection with the EMS for the purpose of informing the EMS that it is available to receive appropriate data and instructions from allowed source entities. Once both the source entity and target entity have established two independent secured connections to the EMS, the EMS can broker a connection allowing the source entity to communicate directly to the target entity. This communication, however, must be secured requiring the source entity and target entity to establish yet another secured connection. The data is then transmitted using this secured connection.

The benefit of establishing a secured connection between the source entity and target entity is twofold: First, despite the fact that the EMS is routing the traffic, the EMS has no way of decrypting the information as it forwards the data from the source to the target and vice versa. This provides a truly secure connection without any chance that the EMS will spy or otherwise retain/disclose sensitive information. Second, the connection speed is much faster because the EMS is not required to perform computationally expensive decryption of data. Specifically, the EMS simply decrypts the initial session information from both the source entity and from the target entity for the purpose of establishing a pass-through connection. Once that connection is established the EMS forwards the data without encryption. Unlike previous computationally expensive and consequently slow methods, the EMS is not receiving data on the source entity secured connection, decrypting that data using the source entity session key, re-encrypting that data using the target entity session key and forwarding that data to the target entity, and repeating this process in reverse should the target send data to the source entity.

The foregoing methods may be used to allow devices, possibly on different networks, to discover, access and authenticate one another. Not only may these devices be on entirely different networks, but the devices may have dynamic addresses and nevertheless be discovered, accessed and authenticated. What follows are non-limiting examples showing how these methods may be used.

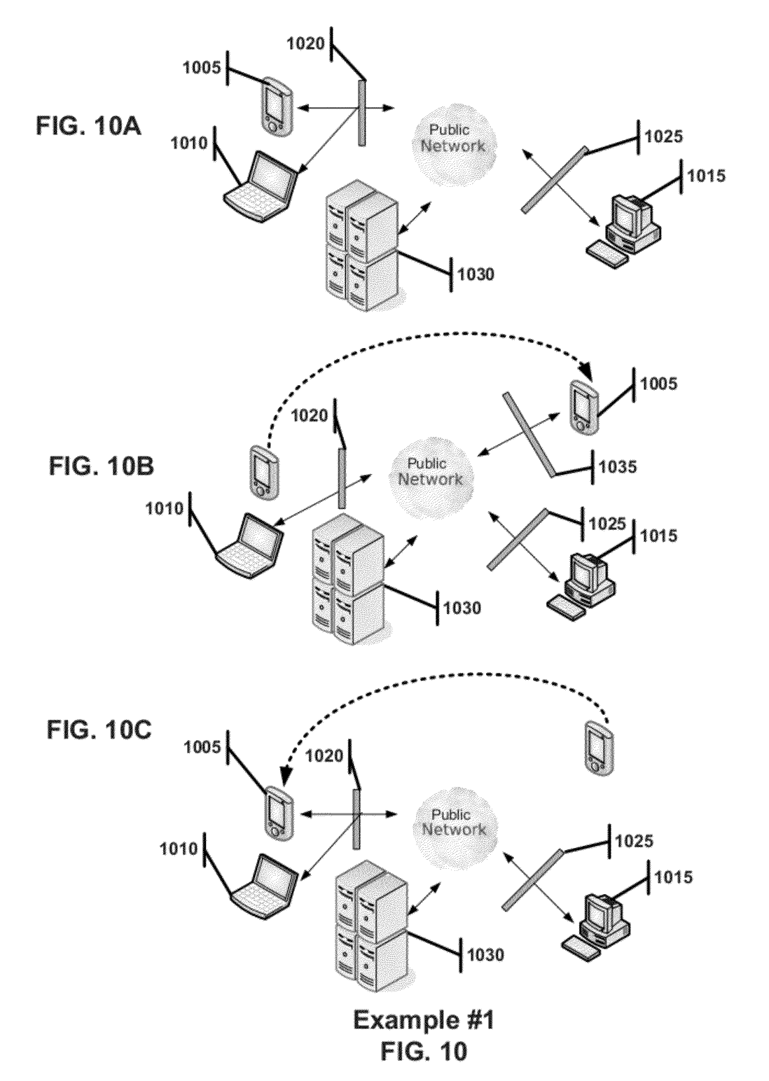

FIG. 10A illustrates example 1, wherein the user has three devices that he would like to discover and access. Those devices are a PDA (1005), a laptop computer (1010) and a desktop computer (1015). Initially, the PDA (1005) and laptop (1010) are at the user's home and both behind a home firewall (1020), and the desktop (1015) is at the user's work and located behind a corporate firewall (1025). All three devices have access to the EMS (1030) through the public network—i.e., the cloud. The user would first need to register with the EMS using method 300 (FIG. 3), which he could do using any of his computing devices. For this example, the user uses his PDA (1005) to contact the EMS (1030) and register as a user. The user then would need to register each device that he would like to access and discover using method 400 (FIG. 4), and for each device the user should establish the rights/permissions for that particular device using method 500 (FIG. 5).

For the sake of illustration, the user registers his PDA (1005) and laptop (1010) and allows these two devices to have complete access rights to each other—i.e., they can access, copy and modify content on each device. When the user arrives at work the following day, he registers his work computer (1015) and sets a more narrow rights/permission—i.e., because of corporate rules the user does not want to modify or save any documents on his work computer (1015) but would only like to access files from the work computer (1015). Now the user has completed the registration of all his devices along with the appropriate permissions.

As is well known, the devices often come online and offline through the day. For example, the PDA (1005) may not have connectivity at the user's workplace but might have public WIFI connectivity when the user has lunch at a coffee shop. This scenario is shown in FIG. 10B, the PDA (1005) is now behind a firewall (1035) of the coffee shop's WIFI network. Since the PDA (1005) lost connectivity, it must register its new network location with the EMS (1030) using methods 600 and 700 (FIGS. 6 and 7). The user's other two devices have also registered their network locations using methods 600 and 700. It is important to note, that had any permissions changed or the location of any of the devices had changed, then during methods 600 and 700, each connected device would have been updated to have the most current information to allow discovery and access of each associated device.

Now that all three devices are connected and their network locations registered, the user may access his other devices according to the permissions/rights he has set. Sitting at the coffee shop with his PDA (1005), the user implements method 800 to connect to this laptop (1010) located behind his home firewall (1020). Recall that he has set the permissions to allow him to have complete access right to his laptop (1010). Because the laptop (1010) is FB (i.e., it is behind a firewall) then the PDA (1005) must establish a connection with the laptop (1010) using method 900 (FIG. 9). After implementing method 900, the user would have complete access to his laptop (1010). Similarly, the user may use methods 800 and 900 to access the desktop computer (1015), but here the PDAs(1005) permission would be more narrow. If permissions provide, the user may remotely transfer files from the remote desktop computer (1015) to the remote laptop (1010).

When the user concludes his lunch, he leaves the coffee shop thus disconnecting his PDA (1005) from the coffee shop's WIFI network. While at work, the user changes the permissions of a particular folder on his desktop computer. In this folder, the user places several personal photos that reside on his work desktop computer (1015). The user specifies the following permission: all contents of the folder can be accessed and and modified by any of the user's other devices; any of the user's devices may write new files to the folder. Because the laptop (1010) is still connected, the new permissions are securely communicated to the laptop (1010).

After work, the user's PDA (1005) has WIFI access to his home network behind firewall (1020), this is shown in FIG. 10C. Since the PDA (1005) lost connectivity, it must register its new network location with the EMS (1030) using methods 600 and 700 (FIGS. 6 and 7). At this time, the PDA (1005) is updated with the new permissions regarding the desktop computer (1015). If the PDA (1005) wants to connect to the home laptop (1010), then it implements method 800 (FIG. 8). As shown in step 805, the last known location for the laptop (1010) is within the PDAs address space. This address is NFB to the PDA (1005) because they are on the same private network; thus the PDA (1005) connects directly to the laptop (1010) without the use of the EMS or method 900 (FIG. 9). The PDA (1005) would also like to access the desktop (1015). But because the desktop (1015) is FB to the PDA (1005), method 900 (FIG. 9) must be used to establish a connection.

This example is limited to a single user with three devices, but it would be apparent that the user could have several devices, all with various access permissions. It should also be apparent that the permissions need not be limited to the user's other devices, but could include devices controlled by other users, as shown below in Example #2.

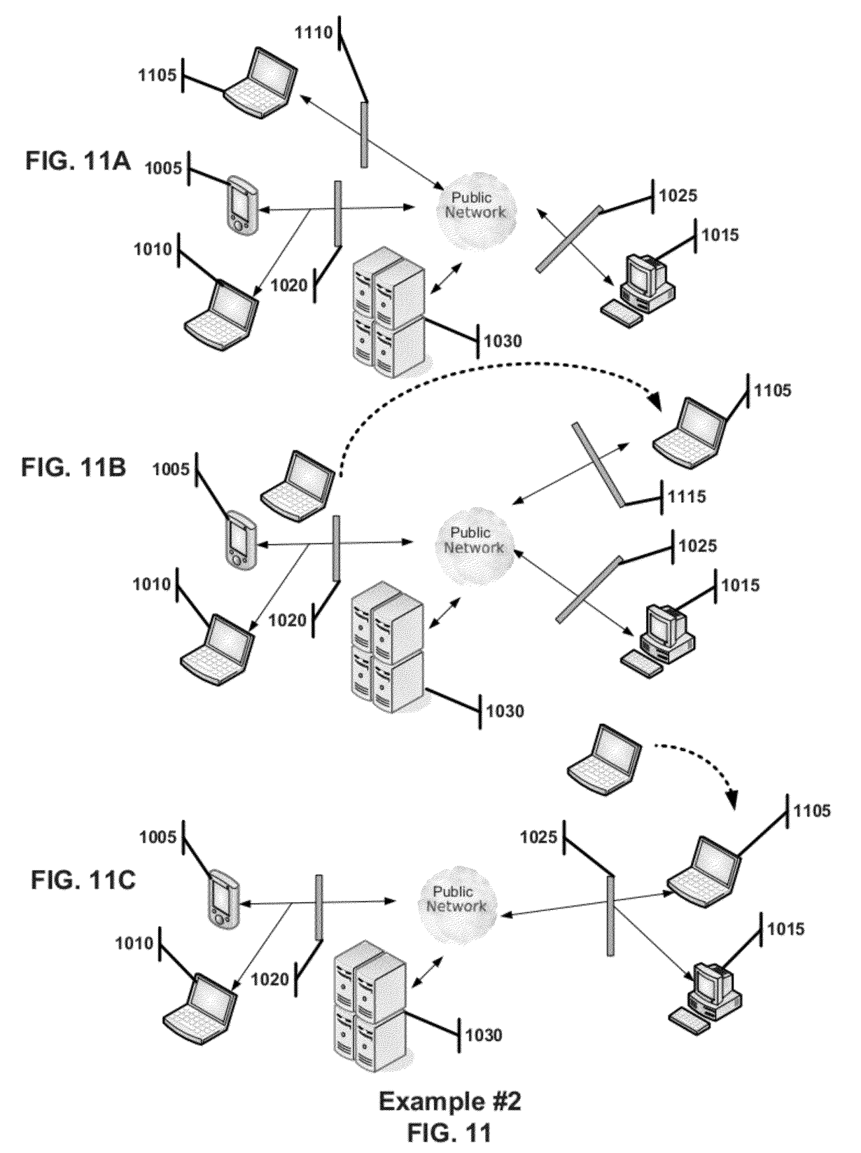

FIG. 11 illustrates Example #2, wherein the same user as in example 1 (FIG. 10) now allows access to his colleague, limited only to his work desktop computer (1015). The colleague also has a laptop computer (1105) that is currently located behind a home firewall (1110) and has access to the EMS (1030) through the cloud. The colleague would first register with the EMS (1030) using method 300 (FIG. 3). The colleague then would need to register his laptop using method 400 (FIG. 4), and the colleague should establish the rights/permissions for that particular device using method 500 (FIG. 5). In this example, the colleague denies all remote access to his laptop (1105)—that is the colleague's laptop (1105) can access remote devices, but not vice versa. The laptop (1105) also registers its network location using methods 600 and 700.

Because the desktop (1015) is the user's device, the user must change the access rules using method 500 (FIG. 5) to allow the colleague to have access. Further, the user may limit access to the personal folder containing his photos, such that the colleague cannot access that folder. The user gives his colleague full access to a selected set of folders on the user's company desktop computer (1015). It should now be apparent that the various users and devices have different access rights, all of which are managed locally, and published to associated devices by the EMS (1030). At this point the laptop (1105) can access the desktop (1015), but because the desktop (1015) is FB to the laptop (1105) method 900 (FIG. 9) must be used to establish a connection.

The colleague's laptop (1105) also has a broadband wireless connection, such that when he travels on the train to work he has access to the EMS (1030). This scenario is shown in FIG. 11B, the laptop (1105) is now behind a firewall (1115) of the broadband connection. Since the laptop (1105) lost connectivity from its original connection to the home network, it must register its new network location with the EMS using methods 600 and 700 (FIGS. 6 and 7). It is important to note, that had any permissions changed or the location of one of the devices had changed, then during methods 600 and 700, each connected device would have been updated to have the most current information to allow discovery and access of each of the user's devices. EMS also pushes network location and permission updates to all connected devices whenever related device locations or permissions are changed. Now that the laptop's (1115) network location has been register it can access the desktop (1015). But because the desktop (1015) is FB to the laptop (1105), method 900 (FIG. 9) must be used to establish a connection.

Once the colleague arrives at work, his laptop (1105) may be able to connect behind the same corporate firewall (1025) as that of the desktop computer (1015) as shown in FIG. 11C. Since the laptop (1105) is changing its connectivity, it must register its new network location with the EMS using methods 600 and 700 (FIGS. 6 and 7). If the laptop (1105) wants to connect to the desktop (1015), then it implements method 800 (FIG. 8). As shown in step 805, location of the desktop (1015) is within the address space of the colleague's laptop (1105). That is, the address is NFB to the laptop (1105) because they are both behind the same firewall. Thus the laptop (1105) connects directly to the desktop (1015) without the use of the EMS (1030) or method 900 (FIG. 9).

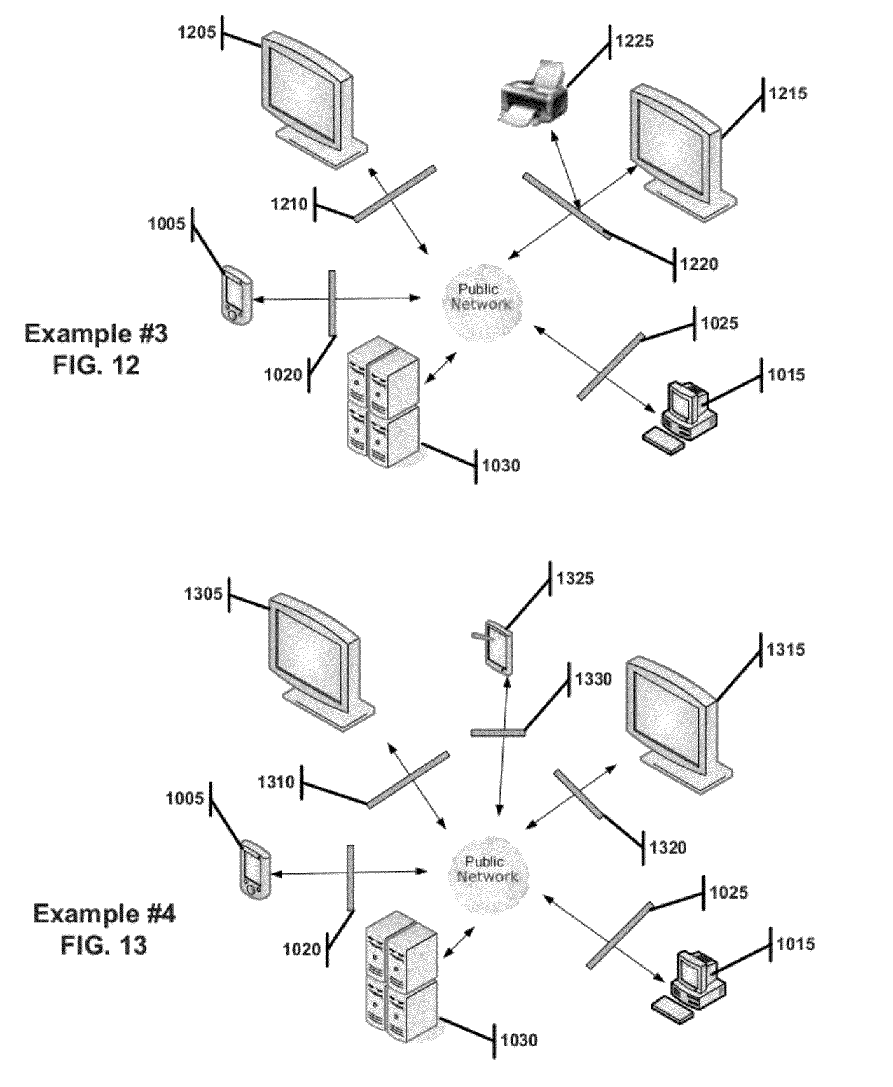

FIG. 12 illustrates Example #3, wherein the same user as in example 1 (FIG. 10) has determined that he would like to share the personal photos that currently reside on his work computer with his mother and brother. As in the previous examples, the user has a PDA (1005) located behind his home firewall (1020), that has connectivity to the EMS (1030) through the cloud. The pictures the user would like to access are located on his work desktop computer (1105) which is located behind a corporate firewall (1025) and has connectivity to the EMS (1030). The user's mother has an addressable flat-panel television (1205) located behind a home firewall (1210) and has connectivity to the EMS (1030) through the cloud. Likewise the user's brother has an addressable flat-panel television (1215) located behind a home firewall (1220) and has connectivity to the EMS (1030). The brother also has an addressable printer (1225) that has connectivity to the EMS (1030). Both the user's brother and mother have registered their respective devices using method 400 (FIG. 4), and have established the rights/permissions for those devices using method 500 (FIG. 5). In this example, the brother and mother allows the user's PDA (1005) to print to the printer (1225) and to display images, files and movies on the flat-panel televisions (1205 and 1215). These devises (1205, 1215 and 1225) also register their network locations using methods 600 and 700.

The photos the user would like to share reside on the desktop computer (1015) that is located behind the corporate firewall (1025). The user must first access these photos, but because the desktop (1015) is FB to the PDA (1005), method 900 (FIG. 9) must be used to establish a connection to retrieve the photos. The user can now instruct the desktop (1015) to send the photos to the flat panel televisions (1205 and 1215), so that those devices can display the photos. Again, however, because the flat panel televisions (1205 and 1215) are FB to the desktop computer (1015), method 900 (FIG. 9) must be used to establish a connection to send and display the photos.

Upon seeing the photos, the user's brother sees a photo that he would like printed. The user can instruct, through his PDA (1005) that the desktop computer (1015) send the photo to the printer (1225). Again, however, because the printer (1225) is FB to the desktop computer (1015), method 900 (FIG. 9) must be used to establish a connection to send and print the photo. It would be apparent that this printing or display device could be anywhere, and so long as it has connectivity to the EMS (1030), the PDA can send it files.

FIG. 13 illustrates Example #4, wherein the same user as in example 1 (FIG. 10) must make a presentation to several colleagues that are in different offices around the world. The Japan office has a flat-panel monitor (1305) located behind the corporate firewall (1310), while the India office has a monitor (1315) located behind corporate firewall (1320). Each of these monitors has access to the EMS (1030) through the cloud. The CEO of the company is currently on a plane flying to the Japanese field office and has a tablet computer (1325) connected to the planes WIFI network that contains a firewall (1330). The monitors and tablet computer have registered using method 400 (FIG. 4) and have established the rights/permissions for those devices using method 500 (FIG. 5). In this example, these devices have allowed the user's PDA (1005) to display images, files and movies to the monitors (1305 and 1315) and the tablet computer (1325). These devices (1305, 1315 and 1325) also register their network locations using methods 600 and 700.

Because the Japanese and India offices begin business when it is late evening for the user, he is at his home with his PDA (1005) located behind his home firewall (1020) at the scheduled time for the presentation. Unfortunately, the presentation that user would like to present resides on the desktop computer (1015) that is located behind the corporate firewall (1025). The user must first access this presentation but because the desktop (1015) is FB to the PDA (1005) method 900 (FIG. 9) must be used to establish a connection to retrieve the presentation. The user can now instruct the desktop (1015) to send the presentation to the monitors (1305 and 1315) and tablet computer (1325), so that those devices can display the photos. Again, however, because these devices (1305, 1315 and 1325) are FB to the desktop computer (1015), method 900 (FIG. 9) must be used to establish a connection to send and display the presentation.

Having described the methods in detail and by reference to several preferred embodiments thereof, it will be apparent that modifications and variations are possible without departing from the scope of the invention defined in the following claims. Moreover, the applicants expressly do not intend that the following claims “and the embodiments in the specification to be strictly coextensive.” Phillips v. AHW Corp., 415 F.3d 1303, 1323 (Fed. Cir. 2005) (en banc).

1. A method for establishing a connection between a source computing device and a target computing device wherein both devices are at least intermittently connected to a network, wherein an entity management system (EMS) is further connected to the network, the method comprising:
(a) the EMS ascertaining the network location of the target device and reporting the network location to the source device;
(b) the source device initiating a connection with the target device based on the network location;
(c) when the connection in (b) is not successful, then:
i. the source device initiating a connection to the EMS;
ii. the source device communicating its desire to EMS to make a connection to the target device;
iii. the EMS determining whether the target device is currently connected to the EMS;
iv. when the target device is connected to the EMS, then:
1. Establishing a communication channel through the EMS such that the source and target devices can communicate with each other;
2. Establishing on the communication channel a trusted communication between the target and source devices using a set of asymmetric and symmetric cryptographic keys; and
3. Routing encrypted communications from the target device to the source and from the source device to the target over the communication channel, wherein the set of asymmetric and symmetric cryptographic keys are not known to the EMS and the encrypted communications are not decipherable by the EMS.

2. The method of claim 1, further comprising:
the EMS providing to source device a public cryptographic key associated with the target device;
the source device generating an encrypted connection request (ECR), wherein the ECR comprising a session key and authenticating information encrypted with the public key associated with the target device;
the source device transmitting the ECR to the target device;
the target device deciphering the ECR with a private key;
the target device verifying the authentication information,
establishing the trusted communication if the authentication information is verified; and
the source and target devices sending encrypting data over the communication channel, wherein the encrypted data is encrypted using the session key.

3. The method of claim 2, further comprising:
the target device generating challenge data; and encrypting the challenge data with the public key associated with the source device;
the target device transmitting the encrypted challenge data to the source device;
the source device deciphering the encrypted challenge data with a private key;
the source device transmitting the challenge data to the target device; and
the target device verifying the challenge data received from the source entity, and establishing the trusted communication upon successful verification.

4. A method for establishing a connection between a source computing device and a target computing device wherein both devices are at least intermittently connected to a network, wherein an entity management system (EMS) is further connected to the network, the method comprising:
(a) the EMS ascertaining the network location of the target device and reporting the network location to the source device;
(b) the source device initiating a connection with the target device based on the network location;
(c) when the connection in (b) is not successful, then:
i. the source device initiating a connection to the EMS;
ii. the source device communicating its desire to EMS to make a connection to the target device;
iii. the EMS determining whether the target device is currently connected to the EMS;
iv. when the target device is connected to the EMS, then:
1. Establishing a communication channel through the EMS such that the source and target devices can communicate with each other;
2. Establishing on the communication channel a trusted communication between the target and source devices using asymmetric and symmetric cryptography; and
3. Routing encrypted communications from the target device to the source and from the source device to the target over the communication channel, wherein the encrypted communications are not decipherable by the EMS.

5. The method of claim 4, further comprising:
the EMS providing to source device a public cryptographic key associated with the target device;
the source device generating an encrypted connection request (ECR), wherein the ECR comprising a session key and authenticating information encrypted with the public key associated with the target device;
the source device transmitting the ECR to the target device;
the target device deciphering the ECR with a private key;
the target device verifying the authentication information,
establishing the trusted communication if the authentication information is verified; and
the source and target devices sending encrypting data over the communication channel, wherein the encrypted data is encrypted using the session key.

6. The method of claim 5, further comprising:
the target device generating challenge data; and encrypting the challenge data with the public key associated with the source device;
the target device transmitting the encrypted challenge data to the source device;
the source device deciphering the encrypted challenge data with a private key;
the source device transmitting the challenge data to the target device; and
the target device verifying the challenge data received from the source entity, and establishing the trusted communication upon successful verification.

7. A method for establishing a connection between a source computing device and a target computing device wherein both devices are connected to an Entity Management Server (EMS) network, the method comprising:
(a) determining the following attributes of the source device: an identifying label; an address within the network where the source device can be located; and a list of other network devices that are authorized to communicate with the source device;
(b) determining the following attributes of the target device: an identifying label; an address within the network where the target device can be located; and a list of other network devices that are authorized to communicate with the target device;
(c) based on the list of authorized devices for the source and target devices, confirming that the source device and target device are authorized to communicate with each other;
(d) establishing a trusted channel between the target and source devices using asymmetric and symmetric cryptographic keys; and
(e) routing encrypted data over the trusted channel from the target device to the source device and from the source device to the target device, wherein the set of asymmetric and symmetric cryptographic keys are not known to the EMS and the encrypted data is not decipherable by the EMS.

8. The method of claim 7, wherein the step (d) further comprises:
the EMS providing to source device a public cryptographic key associated with the target device;
the source device generating an encrypted connection request (ECR), wherein the ECR comprising a session key and authenticating information encrypted with the public key associated with the target device;
the source device transmitting the ECR to the target device;
the target device deciphering the ECR with a private key;
the target device verifying the authentication information and establishing the trusted channel if the authentication information is verified; and
the source and target devices sending encrypting data over the trusted channel, wherein the encrypted data is encrypted using the session key.

9. An entity management server (EMS) for establishing a connection between a source computing device and a target computing device wherein the EMS, the source computing device, and the target computing devices are connected to a network, the EMS comprising:
a memory; and
a computer configured to perform the following steps:
determining the following attributes of the source device: an identifying label;
an address within the network where the source device can be located; and
a list of other network devices that are authorized to communicate with the source device;
storing the attributes of the source device in the memory;
determining the following attributes of the target device: an identifying label;
an address within the network where the target device can be located; and
a list of other network devices that are authorized to communicate with the target device;
storing the attributes of the target device in the memory;
based on the list of authorized devices for the source and target devices, confirming that the source device and target device are authorized to communicate with each other;
establishing a trusted channel between the source and target devices; and
routing encrypted data over the trusted channel from the source device to the target device and from the target device to the source device, wherein the encrypted data is encrypted with a set of asymmetric and symmetric cryptographic keys that are not known to the EMS and the encrypted data is not decipherable by the EMS.

10. A system for routing encrypted data, the system comprising:
a source computing device connected to an Entity Management Server (EMS);
a target computing device connected to the EMS;
the EMS comprising a memory and a computer configured to perform the following steps:
determining the following attributes of the source device: an identifying label;
an address within the network where the source device can be located; and
a list of other network devices that are authorized to communicate with the source device;
storing the attributes of the source device in the memory;
determining the following attributes of the target device: an identifying label;
an address within the network where the target device can be located; and
a list of other network devices that are authorized to communicate with the target device;
storing the attributes of the target device in the memory;
based on the list of authorized devices for the source and target devices, confirming that the source device and target device are authorized to communicate with each other;
establishing a trusted channel between the source and target devices; and
routing encrypted data over the trusted channel from the source device to the target device and from the target device to the source device
wherein the data encryption comprises:
the EMS providing to source device a public cryptographic key associated with the target device;
the source device generating an encrypted connection request (ECR), wherein the ECR comprising a session key and authenticating information encrypted with the public key associated with the target device;
the source device transmitting the ECR to the target device;
the target device deciphering the ECR with a private key;
the target device verifying the authentication information and establishing the trusted channel if the authentication information is verified; and
the source and target devices sending encrypting data over the trusted channel, wherein the encrypted data is encrypted using the session key;
wherein the private key is not known to the EMS and the encrypted data is not decipherable by the EMS.
